(19) United States
(12) Patent Application Publication
(10) Pub. No.: US 2011/0252413 A1
(43) Pub. Date: Oct. 13, 2011

(54) BUS CONTROLLER AND METHOD FOR PATCHING INITIAL BOOT PROGRAM

(75) Inventor: Taro MAEDA, Kyoto (JP)

(73) Assignee: PANASONIC CORPORATION, Osaka (JP)

(21) Appl. No.: 13/165,158

(22) Filed: Jun. 21, 2011

Related U.S. Application Data
(63) Continuation of application No. PCT/JP2009/005267, filed on Oct. 9, 2009.

(30) Foreign Application Priority Data
Dec. 24, 2008 (JP) 2008-328851

(51) Int. Cl. G06F 9/44

(52) U.S. Cl. 717/168

(57) ABSTRACT

A bus controller includes: a boot mode verification circuit which judges whether or not replacement of part of the initial boot program is needed; a patch code transfer sequencer which controls transfer of a patch code including a replacement program from a predetermined address of an external memory, when the boot mode verification circuit judges that the replacement is needed; a patch code buffer which stores the patch code transferred under control of the patch code transfer sequencer; and an access control circuit which detects an address of the part of the initial boot program judged as needing the replacement in the ROM, based on information included in the patch code, and performs the replacement by issuing access to the patch code buffer as replacement access for access to the address of the part of the initial boot program, when the processor issues the access to the address of the part of the initial boot program.

### CROSS REFERENCE TO RELATED APPLICATION

This is a continuation application of PCT application No. PCT/JP2009/005267 filed on Oct. 9, 2009, designating the United States of America.

### BACKGROUND OF THE INVENTION

(1) Field of the Invention

The present invention relates to a bus controller included in a system LSI, and particularly to a method and a device for patching an initial boot program in a system LSI having a built-in ROM boot mode.

(2) Description of the Related Art

Conventionally, there has been a system controlled by a main program for controlling the system and a program which is referred to by the main program and stored in a ROM. When such programs are replaced, as a corresponding method in the case where a bug occurs in the programs, a program to be executed by a processor is replaced by making the processor jump to a patch program so that a program region that needs replacing is not accessed, and by additionally implementing, to the main program, the patch program which implements a new program in a jump destination (refer to Japanese Unexamined Patent Application Publication No. 2005-63311, for instance).

However, in recent years, for the purpose of enhancement of cost competitiveness by using only a flash memory for main program as an external memory, it has been required to develop a system LSI which stores, in a ROM built into the system LSI, an initial boot program of the system, and has a built-in ROM boot mode in which, at the time of system initial boot, a processor is booted from the initial boot program stored in the built-in ROM. Nonetheless, since the initial boot program is processed prior to execution of a main program and is burned onto the ROM, in the case where a bug is detected, it is impossible to avoid the bug by subsequent patching, and mask correction is required when the bug occurs, which causes significant business impacts including correction costs.

### SUMMARY OF THE INVENTION

The present invention has been devised in view of the above circumstance, and has an object to provide a bus controller or the like which is included in a system LSI having a built-in ROM boot mode, and makes it possible to revise an initial boot program stored in the system LSI.

In order to achieve the object, a bus controller according to the present invention is a bus controller included in a system LSI (Large-Scale Integration) having a built-in ROM boot mode in which a processor in the system LSI starts by executing an initial boot program stored in a ROM (Read Only Memory) built into the system LSI, the bus controller including: a boot mode verification circuit configured to judge whether or not replacement of part of the initial boot program is needed, based on boot mode information set according to a state of an external terminal of the system LSI; a patch code transfer sequencer which controls transfer of a patch code including a replacement program from a predetermined address of an external memory, when the boot mode verification circuit judges that the replacement is needed; a patch code buffer which stores the patch code transferred under control of the patch code transfer sequencer; and an access control circuit which detects an address of the part of the initial boot program judged as needing the replacement in the ROM, based on information included in the patch code, and performs the replacement by issuing access to the patch code buffer as replacement access for access to the address of the part of the initial boot program, when the processor issues the access to the address of the part of the initial boot program. With this, a bug in the initial boot program is replaced with a patch program transferred from the external memory to the bus controller and the patch program is executed, and thus even the system LSI having the built-in ROM boot mode makes it possible to apply a patch to the initial boot program without mask correction of the built-in ROM.

Moreover, the patch code includes transfer size information indicating a transfer size of the patch code, and the patch code transfer sequencer may determine the transfer size of the patch code with reference to the transfer size information of the patch code, and perform the transfer corresponding to an amount of the replacement according to the transfer size information of the patch code. With this, the transfer corresponding to the amount of the replacement according to the transfer size information is performed, and thus the unnecessary transfer time is reduced.

Moreover, the patch code includes transfer timing information indicating a transfer timing of the patch code, and the patch code transfer sequencer may determine the transfer timing of the patch code with reference to the transfer timing information of the patch code, and dynamically transfer the patch code to the patch code buffer with the determined transfer timing. With this, the data is dynamically transferred to the patch code buffer, and thus it is possible to downsize the patch code buffer and reduce the unnecessary transfer time.

Moreover, the initial boot program includes an instruction to start the patch code transfer sequencer, and the patch code transfer sequencer includes an interface unit which may receive a boot instruction from the processor, and start the transfer of the patch code upon receiving the boot instruction from the processor through the interface unit. With this, the replacement of the built-in ROM data is achieved without verification of a boot mode.

Moreover, the access control circuit may judge whether the transferred patch code is valid or invalid, and perform the replacement only when data of the transferred patch code is judged to be valid. With this, the external terminal does not need to determine the presence or absence of the patch code.

Moreover, the access control circuit may issue wait control to the processor by transmitting, to the processor, a loop instruction during a transfer processing period, when the processor issues the access to the address of the part of the initial boot program while the patch code transfer sequencer is transferring the patch code. With this, timeout is prevented from occurring during the patch code transfer period, by safely issuing the wait control to the processor.

It is to be noted that the present invention is achieved not only as the bus controller but also as a method for patching an initial boot program in a system LSI having a built-in ROM boot mode.

By including the bus controller according to the present invention, it is possible to revise, without mask correction, the initial boot program stored in the ROM built into the system LSI which cannot avoid the bug in the main program using a major conventional patching method, at low cost. In other words, it is possible to apply, in the system LSI having the built-in ROM boot mode, the patch to the initial boot program without mask correction. Further, the present invention is a technique applicable to add functions to the initial boot program, which leads to extend service life of the system LSI as a product.

### FURTHER INFORMATION ABOUT TECHNICAL BACKGROUND TO THIS APPLICATION

The disclosure of Japanese Patent Application No. 2008-328851 filed on Dec. 24, 2008 including specification, drawings and claims is incorporated herein by reference in its entirety.

The disclosure of PCT application No. PCT/JP2009/005267 filed on Oct. 9, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration example of a bus controller according to an embodiment of the present invention;

FIG. 2 is a timing diagram showing exemplary operation of the bus controller according to the embodiment of the present invention;

FIG. 3 is a diagram showing an exemplary data structure of a patch code;

FIG. 4 is a timing diagram showing exemplary operation in transfer size analysis that is an extension function of the bus controller in the present invention;

FIG. 5 is a diagram showing another exemplary data structure of a patch code;

FIG. 6 is a timing diagram showing exemplary operation in transfer timing analysis that is an extension function of the bus controller in the present invention;

FIG. 7A is a diagram showing still another exemplary data structure of a patch code, and FIG. 7B is a flowchart showing example operation of the bus controller according to the present invention which uses the patch code; and

FIG. 8 is a diagram showing an exemplary sequence of instructions included in an initial boot program.

### DESCRIPTION OF THE PREFERRED EMBODIMENT

The following describes an embodiment of the present invention.

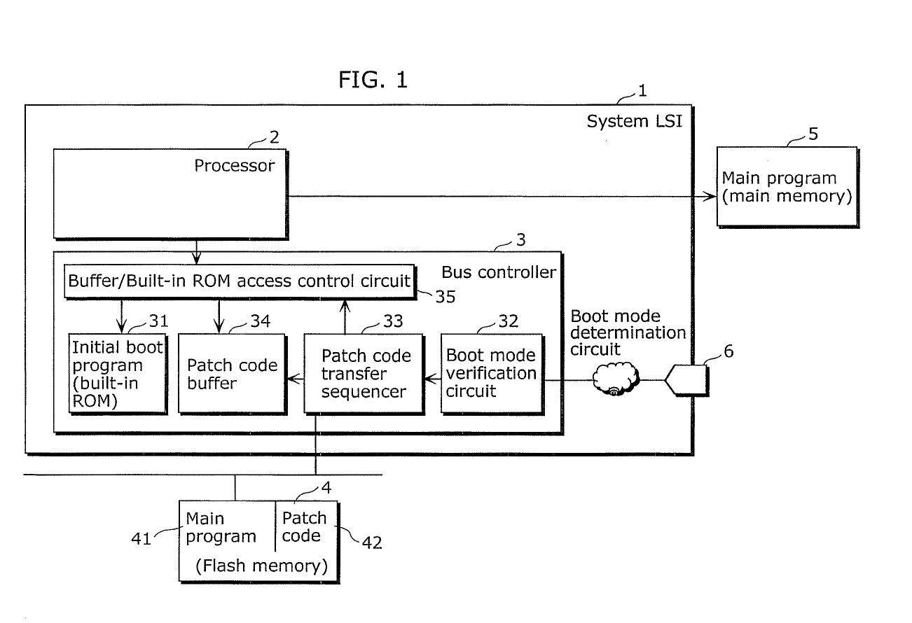

FIG. 1 is a block diagram showing a configuration example of a system using a system LSI 1 including a bus controller 3 according to this embodiment of the present invention. A brief configuration and operation of the bus controller 3 according to the present invention are described with reference to FIG. 1.

The following describes the configuration example of the system using the system LSI 1 including the bus controller 3 according to the present invention, and an outline of a boot sequence. The system LSI 1 shown by the example includes a processor 2 which controls the whole system LSI 1 and the bus controller 3 according to the present invention. The bus controller 3 is included in the system LSI 1 having a built-in ROM boot mode in which the system LSI 1 starts by executing an initial boot program 31 stored in a ROM (Read Only Memory) built into the system LSI 1, and has a configuration of a conventional bus controller including the initial boot program stored in the built-in ROM, to which a boot mode verification circuit 32, a patch code transfer sequencer 33, a patch code buffer 34, and a buffer/built-in ROM access control circuit 35 are added. Examples of the system using the system LSI 1 including the bus controller 3 according to this embodiment of the present invention include a system connected to an external flash memory 4 storing a main program 41 and a main memory 5. As for a flow of system boot, when reset is canceled, the processor 2 first executes the initial boot program 31 stored in the built-in ROM, and transfers the main program 41 to the main memory 5. Subsequently, the processor 2 executes the main program transferred to the main memory 5, thereby controlling the whole system.

The following describes the elements included in the bus controller 3 according to the present invention.

The boot mode verification circuit 32 judges whether or not replacement of part of the initial boot program 31 is needed, based on boot mode information set according to a state of an external terminal 6 of the system LSI 1. When the boot mode verification circuit 32 judges that the replacement is needed, the boot mode verification circuit 32 transmits, to the patch code transfer sequencer 33, a boot signal for transferring, to the patch code buffer 34, a patch code 42 which is in a specific region of the external flash memory 4 and includes a replacement program.

The patch code transfer sequencer 33 receives the boot signal (i.e., a patch code transfer request) from the boot mode verification circuit 32, obtains the patch code 42 in the specific region of the external flash memory 4 prior to boot of the processor 2, analyzes a header of the patch code 42, and transfers a program to the patch code buffer 34. During a period of transferring the patch code 42, the patch code transfer sequencer 33 issues wait control to the processor 2 by transmitting a loop instruction to the processor 2. More specifically, during the period of transferring the patch code 42, the patch code transfer sequencer 33 notifies an access wait request to the buffer/built-in ROM access control circuit 35 so that the processor 2 operates not to be hanged (or timeout), by transmitting a wait and loop instruction to the processor 2, and permits the processor 2 to access the initial boot program 31 upon the completion of the transfer. An address in which the patch code 42 is stored is defined by an arrangement at a time of implementation by the patch code transfer sequencer 33. An address of the initial boot program 31 to which replacement of the initial boot program 31 by the patch code 42 is applied is specified by address information provided as a header part of the patch code 42. The patch code transfer sequencer 33 separates, into a program part and a header part, the patch code 42 including the header part including the address information. The program part is stored in the patch code buffer 34. The patch code transfer sequencer 33 holds the header part as control information, and transmits, to the buffer/built-in ROM access control circuit 35, the address information in the header part as address information for replacement access to the patch code buffer 34.

The patch code buffer 34 stores the program part of the patch code 42. The program part of the patch code 42 is stored by the patch code transfer sequencer 33. The processor 2 accesses the stored program part of the patch code 42 based on an access judgment by the buffer/built-in ROM access control circuit 35.

The buffer/built-in ROM access control circuit 35 analyzes the access from the processor 2 based on the address information for replacement access from the patch code transfer sequencer 33, issues, as replacement access, access to the patch code buffer 34 when the access from the processor 2 hits an address for patching, and issues access to the initial boot program 31 when the access from the processor 2 does not hit the address for patching. In addition, the buffer/built-in ROM access control circuit 35 detects the access wait request which the patch code transfer sequencer 33 transmits during the period of transferring the patch code 42, and transmits a wait loop instruction to the processor 2 during a period when the access wait request is detected.

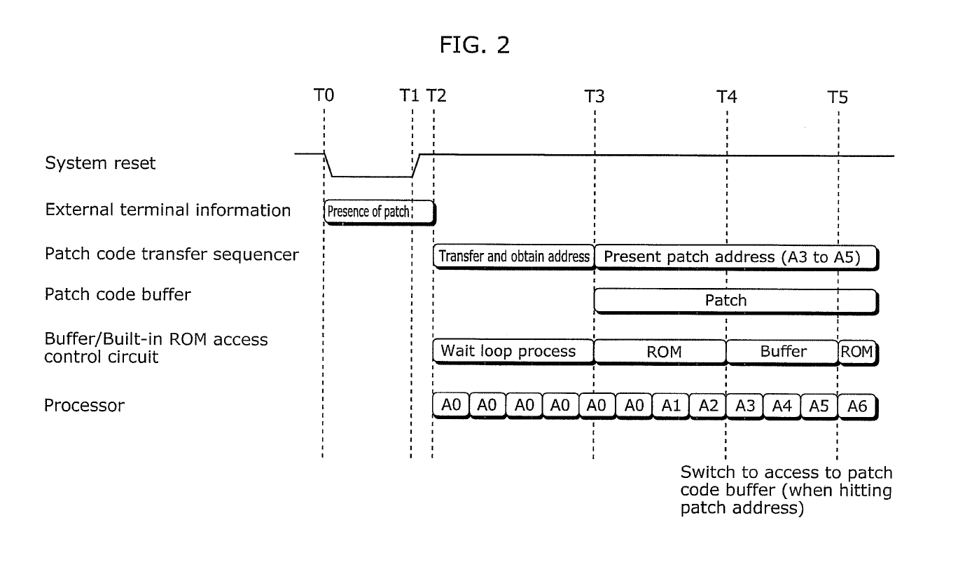

The following describes a series of the above operation with reference to FIG. 2. The system LSI 1 is reset during a period from T0 to T1. Information indicating presence of patch code is set to the external terminal 6 during the period. The information indicating the presence of patch code is transmitted to the boot mode verification circuit 32 right after T1 which is a reset cancellation timing, and subsequently the patch code transfer sequencer 33 is started with timing T2. The started patch code transfer sequencer 33 always obtains the patch code 42 stored in the external flash memory 4, and analyzes a header including a patch address and stores a program into the patch code buffer 34 during a period up to T3. During that period, although the processor 2 of which reset is canceled issues access to address A0 to fetch the initial boot program 31, the buffer/built-in ROM access control circuit 35 issues, to the processor 2, an instruction indicating a wait loop process, and thus the processor 2 repeatedly accesses the address A0. The patch code transfer sequencer 33 finishes obtaining the patch address from the patch code and storing the program into the patch code buffer 34 with timing T3, and notifies the buffer/built-in ROM access control circuit 35 of completion of transfer of the patch address. The buffer/built-in ROM access control circuit 35 to which the completion of the transfer of the patch code 42 has been notified terminates the wait loop process performed on the processor 2, and switches the access by the processor 2 to either the initial boot program 31 or the patch code buffer 34 based on comparison between the access address from the processor 2 and the patch address presented by the patch code transfer sequencer 33. Through the above sequence, patching (replacing) the initial boot program 31 is achieved.

Next, the following describes additional functions of the bus controller 3 according to this embodiment.

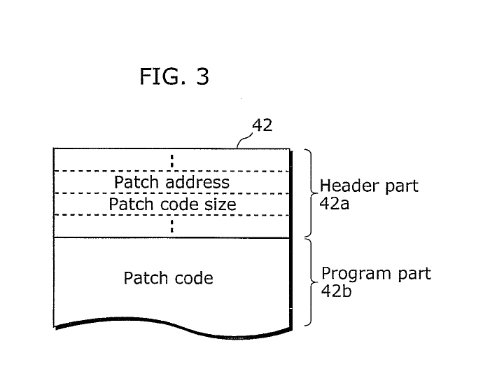

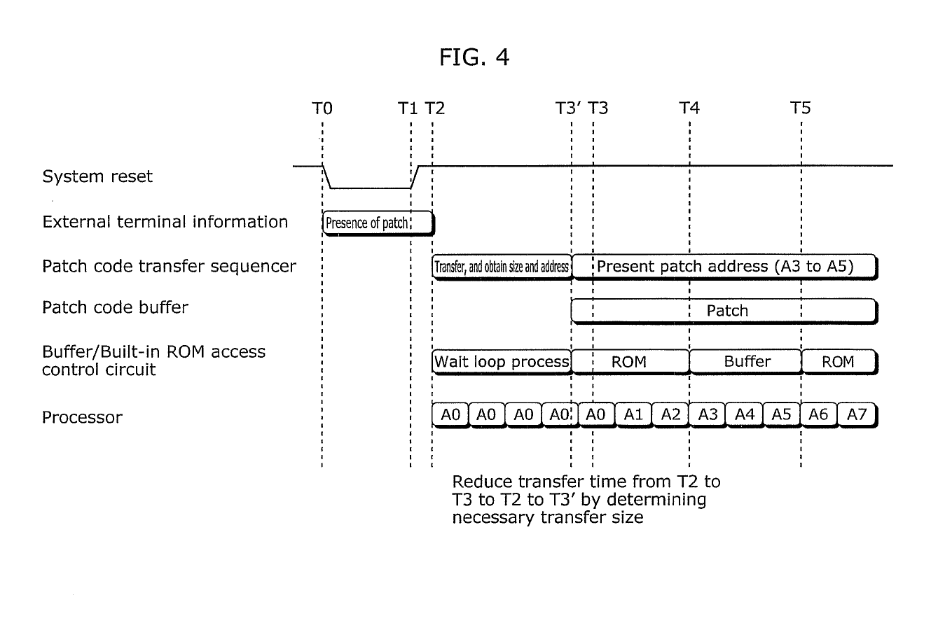

The patch code transfer sequencer 33 may determine a patch code size of a patch code to be transmitted. In this case, as shown in FIG. 3, not only the patch address (the above-mentioned address information (address for patching)) but also information specifying a patch code size (transfer size information; “patch code size” in the figure) are provided in advance as a header part 42a of the patch code 42 including the header part 42a and a program part 42b. The patch code transfer sequencer 33 has an operation mode in which patch code size information is detected and a necessary minimum amount of a patch code is transferred to the patch code buffer 34. Having the operation mode makes it possible to only transfer data necessary as the patch code, and redundant data transfer unnecessary for patching does not need to be performed, which leads to reduction in a system boot time. Although a period from T2 to T3 shown in FIG. 2 is a patch code transfer time, as shown in FIG. 4, it is possible to reduce, to T3′, a patch code transfer completion time that is timing T3 at the time of fixed size transfer, by obtaining the patch code size information at the time of obtaining the patch code and transferring data having a necessary size.

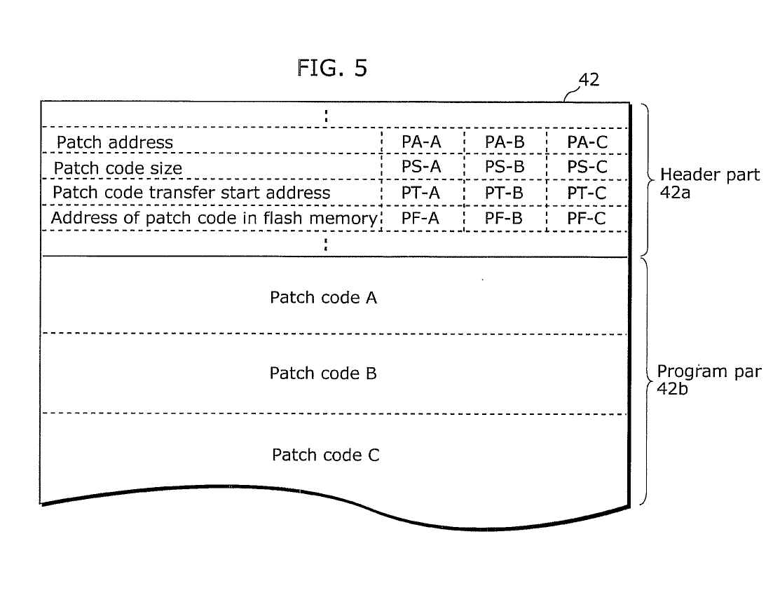

Moreover, the patch code transfer sequencer 33 may determine a transfer timing of the patch code 42, and voluntarily start transferring the patch code 42. Here, it is assumed that replacement programs corresponding to parts of the initial boot program or function adding programs are stored in the patch code 42. In this case, as shown in FIG. 5, the header part 42a of the patch code 42 includes, as transfer timing information indicating the transfer timing of the patch code 42, patch addresses PA-A, PA-B, and PA-C, patch code sizes PS-A, PS-B, and PS-C, patch code transfer start addresses PT-A, PT-B, and PT-C, and addresses of patch code in flash memory PF-A, PF-B, and PF-C of functional programs A, B, and C (“Patch code A, Patch code B, and Patch code C” in the figure) included in the patch code 42. The patch code transfer sequencer 33 first analyzes header information, obtains a patch address, a patch code size, and a patch code transfer start address, and notifies the buffer/built-in ROM access control circuit 35 of patch code transfer start address information in addition to the patch address. When the access from the processor 2 reaches an address indicated by the patch code transfer start address, the patch code transfer start address is used for starting transfer of a patch code. The buffer/built-in ROM access control circuit 35 to which the patch code transfer start address has been notified enters the wait loop process, when the address of the access from the processor 2 hits the patch code transfer start address. Then, the buffer/built-in ROM access control circuit 35 transmits, to the patch code transfer sequencer 33, a patch code transfer boot request together with hit address information. The patch code transfer sequencer 33 which has received the address information and the patch code transfer boot request transfers, from the address of the patch code in the flash memory, a patch code having a patch code size as a corresponding patch code.

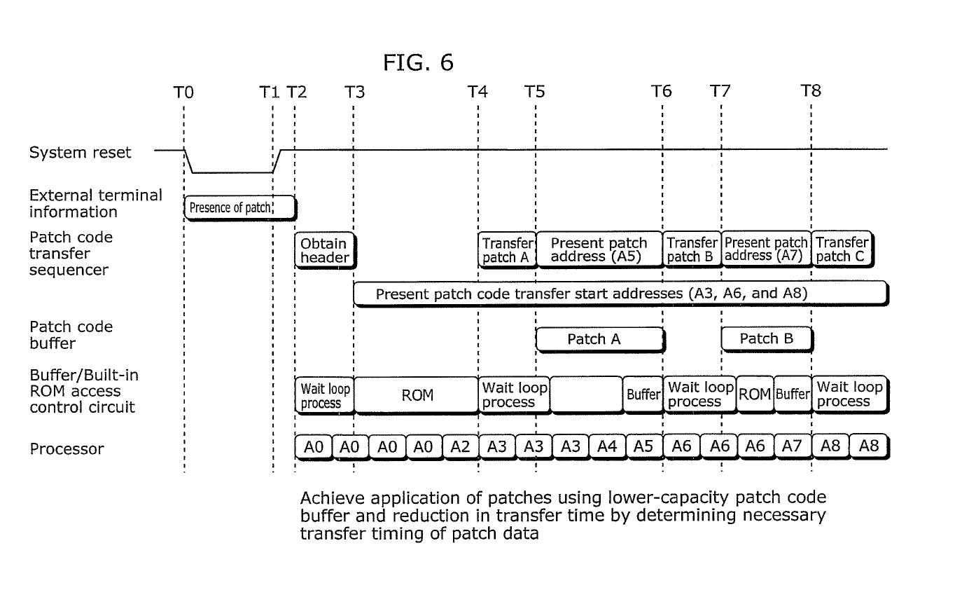

FIG. 6 is a timing diagram showing exemplary operation in the transfer timing analysis as described above. The patch code transfer sequencer which has been started with the timing T2 only transfers the header part 42a of the patch code 42, and obtains the transfer timing information included in the header part 42a of the patch code 42. Subsequently, the access address of the processor 2 matches the patch code transfer start address with the timing T4, and the buffer/built-in ROM access control circuit 35 enters the wait loop process with respect to the processor 2, and starts the patch code transfer sequencer 33. The patch code transfer sequencer 33 presents a patch address to the buffer/built-in ROM access control circuit 35 by completing, with timing T5, transfer of the access address of the processor 2, the patch code transfer start address, and the patch code A based on a boot request to the patch code buffer 34, and applies a patch code. Then, when a second patch code transfer start address is reached with timing T6, the buffer/built-in ROM access control circuit 35 enters the wait loop process again, and the patch code transfer sequencer 33 transfers the patch code B and applies a patch code in the same manner as above. Having this mode makes it possible to apply patches using a lower-capacity patch code buffer. In addition, since a patch code is transferred only when required such as a case where present is a patch code necessary only at the time of using some of modes of the system LSI 1, it is possible to reduce a data transfer time in comparison with a case where patch codes are collectively transferred.

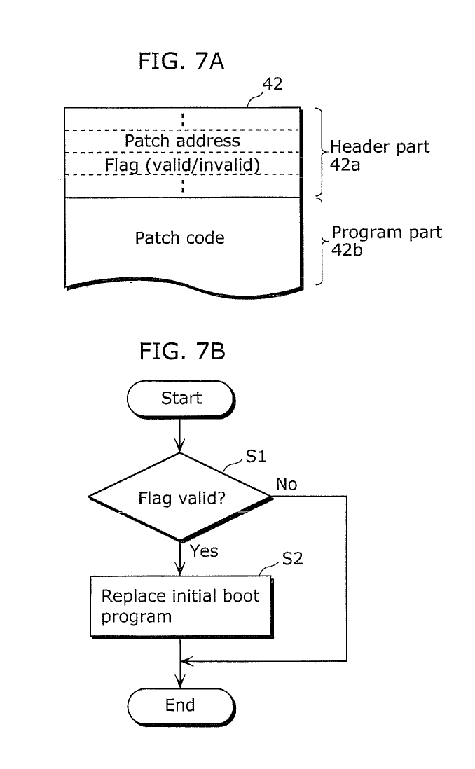

Moreover, the patch code transfer sequencer 33 may judge whether each of patch codes is valid or invalid. In this case, as shown by the data structure diagram of the patch code in FIG. 7A, the header part 42 of the patch code 42 may include a flag indicating validity/invalidity of each patch code. When the patch code transfer sequencer 33 detects the flag indicating the invalidity of the patch code, the patch code transfer sequencer 33 does not present the corresponding patch address to the buffer/built-in ROM access control circuit 35. In other words, as in the flowchart shown by FIG. 7B, only when the data of the transferred patch code indicates validity (S1), having a mode in which the initial boot program is replaced (S2) does not require the external terminal 6 to judge presence or absence of the patch code, and thus it is possible to remove assignment of the external terminal 6 or a judgment circuit. However, patch code transfer inevitably occurs in the case of the absence of the patch code.

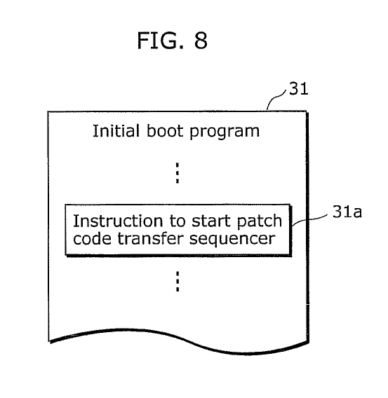

Moreover, the patch code transfer sequencer 33 may include an interface (I/F) unit which enables the processor 2 to start. In other words, the patch code transfer sequencer 33 includes the I/F unit which receives a boot instruction from the processor 2, and may start transferring a patch code upon receiving the boot instruction from the processor 2 through the I/F unit. Having this mode (I/F unit) and, as shown in FIG. 8, including a boot instruction 31a of the patch code transfer sequencer 33 in the initial boot program 31 do not require the external terminal 6 to determine the presence or absence of the patch code, and thus it is possible to remove the assignment of the external terminal 6 or the judgment circuit. However, the patch code transfer inevitably occurs in the case of the absence of the patch code.

The bus controller according to the present invention has been described above based on this embodiment, the present invention is not limited to this embodiment. For instance, the additional functions included in the bus controller, that is, determining the transfer size of the patch code, determining the transfer timing of the patch code, the I/F unit which enables the processor to start, judging the validity or the invalidity of the patch code, and so on may be all implemented, or a combination of any of the functions may be implemented.

Moreover, although the bus controller 3 includes the built-in ROM storing the initial boot program 31 in this embodiment, such a built-in ROM may be included in the system LSI 1, and is not necessarily included in the bus controller 3.

### INDUSTRIAL APPLICABILITY

The bus controller according to the present invention makes it possible to patch an initial boot program which cannot be patched by a main program, especially in a system LSI having a built-in ROM boot mode, and thus is useful as a bus controller included in the system LSI having the built-in ROM boot mode.

What is claimed is:

1. A bus controller included in a system LSI (Large-Scale Integration) having a built-in ROM boot mode in which a processor in the system LSI starts by executing an initial boot program stored in a ROM (Read Only Memory) built into the system LSI, said bus controller comprising:
a boot mode verification circuit configured to judge whether or not replacement of part of the initial boot program is needed, based on boot mode information set according to a state of an external terminal of the system LSI;
a patch code transfer sequencer which controls transfer of a patch code including a replacement program from a predetermined address of an external memory, when said boot mode verification circuit judges that the replacement is needed;
a patch code buffer which stores the patch code transferred under control of said patch code transfer sequencer; and
an access control circuit which detects an address of the part of the initial boot program judged as needing the replacement in the ROM, based on information included in the patch code, and performs the replacement by issuing access to said patch code buffer as replacement access for access to the address of the part of the initial boot program, when the processor issues the access to the address of the part of the initial boot program.

2. The bus controller according to claim 1,
wherein the patch code includes transfer size information indicating a transfer size of the patch code, and
said patch code transfer sequencer determines the transfer size of the patch code with reference to the transfer size information of the patch code, and performs the transfer corresponding to an amount of the replacement according to the transfer size information of the patch code.

3. The bus controller according to claim 1,
wherein the patch code includes transfer timing information indicating a transfer timing of the patch code, and
said patch code transfer sequencer determines the transfer timing of the patch code with reference to the transfer timing information of the patch code, and dynamically transfers the patch code to said patch code buffer with the determined transfer timing.

4. The bus controller according to claim 1,
wherein the initial boot program includes an instruction to start said patch code transfer sequencer, and
said patch code transfer sequencer includes an interface unit configured to receive a boot instruction from the processor, and start the transfer of the patch code upon receiving the boot instruction from the processor through said interface unit.

5. The bus controller according to claim 1,
wherein said access control circuit judges whether the transferred patch code is valid or invalid, and performs the replacement only when data of the transferred patch code is judged to be valid.

6. The bus controller according to claim 1,
wherein said access control circuit issues wait control to the processor by transmitting, to the processor, a loop instruction during a transfer processing period, when the processor issues the access to the address of the part of the initial boot program while said patch code transfer sequencer is transferring the patch code.

7. A patching method of replacing an initial boot program stored in a ROM built in the system LSI (Large-Scale Integration) having a built-in ROM boot mode that is a mode in which a processor in the system LSI starts by executing the initial boot program, said patching method comprising:
judging whether or not replacement of part of the initial boot program is needed;
reading out a patch code including a replacement program from a predetermined address in an external memory and transferring the patch code to a patch code buffer, only when it is judged in said judging that the replacement is needed; and
detecting an address of the part of the initial boot program judged as needing the replacement in the ROM, based on information included in the patch code, and performing the replacement by issuing access to the patch code buffer as replacement access for access to the address of the part of the initial boot program, when the processor issues the access to the address of the part of the initial boot program.
